(19) United States
(12) Patent Application Publication
(10) Pub. No.: US 2025/0286135 A1
(43) Pub. Date: Sep. 11, 2025

(54) RECHARGEABLE LITHIUM BATTERIES

(71) Applicant: SAMSUNG SDI CO., LTD., Yongin-si (KR)

(72) Inventors: Yeji YANG, Yongin-si (KR); Sanghoon KIM, Yongin-si (KR); Hyunbong CHOI, Yongin-si (KR); Injun PARK, Yongin-si (KR); Sangwoo PARK, Yongin-si (KR); Sohee KIM, Yongin-si (KR); Hongryeol PARK, Yongin-si (KR); Sundae KIM, Yongin-si (KR)

(73) Assignee: SAMSUNG SDI CO., LTD., Yongin-si (KR)

(21) Appl. No.: 19/069,957

(22) Filed: Mar. 4, 2025

(30) Foreign Application Priority Data
Mar. 8, 2024 (KR) 10-2024-0033390

(51) Int. Cl. H01M 10/0567; H01M 4/02; H01M 4/505; H01M 4/525; H01M 10/052

(52) U.S. Cl. CPC H01M 10/0567; H01M 4/505; H01M 4/525; H01M 10/052; H01M 2004/021; H01M 2004/028

(57) ABSTRACT

Provided are a rechargeable lithium battery including a positive electrode, a negative electrode, a separator, and an electrolyte solution, wherein the positive electrode includes a positive electrode active material including a layered lithium nickel-manganese-based composite oxide, the electrolyte solution includes a non-aqueous organic solvent, a lithium salt, and an additive. The rechargeable lithium battery has improved rapid charging characteristics and reduced or suppressed increase in resistance within the battery, ensuring battery safety and high temperature reliability under high-voltage operating conditions, and improving capacity characteristics and lifecycle characteristics.

### CROSS-REFERENCE TO RELATED APPLICATION

This application claims the benefit of priority to Korean Patent Application No. 10-2024-0033390 filed in the Korean Intellectual Property Office on Mar. 8, 2024, the entire contents of which are incorporated herein by reference.

### BACKGROUND

### 1. Field

Rechargeable lithium batteries are disclosed.

### 2. Description of the Related Art

Rechargeable lithium batteries are widely used as a driving power source for mobile information terminals such as, e.g., smart phones, laptops, and the like, because they are easy to carry while capable of generating high energy density. Accordingly, rechargeable lithium batteries having high capacity, high energy density, and high safety to be used as a power source for driving, e.g., hybrid vehicles or electric vehicles, or as power sources for power storage may be advantageous.

In a rechargeable lithium battery, an electrolyte plays a role in delivering lithium ions, and an electrolyte solution including an organic solvent and a lithium salt is most commonly used because the lithium salt can exhibit high ionic conductivity. The electrolyte solution plays a role in determining safety and performance of the rechargeable lithium battery.

As high-capacity, high-energy density batteries are required, batteries are typically designed to be driven at a high voltage of 4.45 V, or more as well as to increase high density of electrodes. However, under severe conditions such as, e.g., high voltage or high-speed charging, since a positive electrode is deteriorated, and lithium dendrites grow on surface of a negative electrode, which accelerate a side reaction between the electrodes and the electrolyte solution, there is a battery safety problem due to a decrease in a battery lifecycle, gas generation, and the like.

In order to solve this problem, methods of protecting the electrodes through a surface treatment to reduce or suppress the side reaction of the electrodes with the electrolyte solution have been suggested. However, the surface treatment of the positive electrode typically does not exhibit sufficient protection under high voltage driving conditions, and the surface treatment of the negative electrode deteriorates the capacity thereof. Accordingly, developing an electrolyte solution that can improve the safety and lifecycle characteristics of high-capacity and high-voltage battery systems may be advantageous.

### SUMMARY

Example embodiments include an electrolyte solution for a rechargeable lithium battery including stable film formation that improves rapid charging characteristics and reduces or suppresses the increase in resistance within the battery, ensures battery safety and high-temperature reliability under high-voltage operating conditions, and improves capacity and lifecycle characteristics, and a rechargeable lithium battery including the electrolyte solution.

In some example embodiments, a rechargeable lithium battery includes a positive electrode, a negative electrode, a separator, and an electrolyte solution, wherein the positive electrode includes a positive electrode active material including a layered lithium nickel-manganese-based composite oxide, the electrolyte solution includes a non-aqueous organic solvent, a lithium salt, and an additive, and the additive includes a compound represented by Chemical Formula 1.

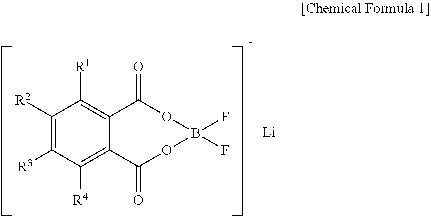

In Chemical Formula 1, R¹ to R⁴ each independently include hydrogen, a substituted or unsubstituted C1 to C20 alkyl group, a substituted or unsubstituted C2 to C20 alkenyl group, a substituted or unsubstituted C2 to C20 alkynyl group, a substituted or unsubstituted C6 to C20 aryl group, a substituted or unsubstituted C3 to C20 cycloalkyl group, a substituted or unsubstituted C3 to C20 cycloalkenyl group, a substituted or unsubstituted C3 to C20 cycloalkynyl group, a substituted or unsubstituted C2 to C20 heterocycloalkyl group, a substituted or unsubstituted C2 to C20 heterocycloalkenyl group, a substituted or unsubstituted C2 to C20 heterocycloalkynyl group, a substituted or unsubstituted C3 to C20 heteroaryl group, a substituted or unsubstituted C1 to C20 alkoxy group, an ester group, an ether group, a carboxyl group or a salt thereof, a cyano group, a carbonyl group, an imino group, or a halogen group.

The rechargeable lithium battery according to some example embodiments has improved rapid charging characteristics, and reduced or suppressed increase in resistance within the battery, ensuring or improving battery safety and high temperature reliability under high-voltage operating conditions, and improving capacity characteristics and lifecycle characteristics.

### BRIEF DESCRIPTION OF THE DRAWINGS

FIGS. 1 to 4 are schematic diagrams illustrating rechargeable lithium batteries according to some example embodiments.

### DETAILED DESCRIPTION

Hereinafter, example embodiments will be described in detail so that those of ordinary skill in the art can readily implement the embodiments. However, this disclosure may be embodied in many different forms and is not construed as limited to the example embodiments set forth herein.

The terminology used herein is used to describe example embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by an optical microscope photograph such as a transmission electron micrograph or a scanning electron micrograph. Alternatively, it is possible to obtain an average particle diameter value by measuring using a dynamic light scattering method, performing data analysis, counting the number of particles for each particle size range, and calculating from this. Unless otherwise defined, the average particle diameter (D₅₀) may mean the diameter of particles having a cumulative volume of 50 volume % in the particle size distribution. D₅₀ may be measured by a particle size analyzer using a laser diffraction method for the particles.

Herein, “or” is not to be construed as an exclusive meaning, for example, “A or B” is construed to include A, B, A+B, and the like.

As used herein, unless otherwise defined, “substituted” refers to replacement of at least one hydrogen in a substituent or compound by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a C1 to C10 fluoroalkyl group, a cyano group, or a combination thereof. An alkyl group may comprise a linear and/or chain alkyl group. A cycloalkyl group may comprise a cyclic alkyl group.

Specifically, “substituted” refers to replacement of at least one hydrogen in a substituent or compound by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, “substituted” refers to replacement of at least one hydrogen in a substituent or compound by deuterium, a halogen group, a C1 to C20 alkyl group, a C6 to C30 aryl group, a C1 to C10 fluoroalkyl group, or a cyano group. Alternatively, “substituted” refers to replacement of at least one hydrogen in a substituent or compound by deuterium, a halogen group, a C1 to C5 alkyl group, a C6 to C18 aryl group, a C1 to C5 fluoroalkyl group, or a cyano group. For example, “substituted” refers to replacement of at least one hydrogen in a substituent or compound by deuterium, a cyano group, a halogen group, a methyl group, an ethyl group, a propyl group, a butyl group, a phenyl group, a biphenyl group, a terphenyl group, a trifluoromethyl group, or a naphthyl group.

Expressions such as C1 to C30 mean that the number of carbon atoms is 1 to 30.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Electrolyte Solution

In some example embodiments, a rechargeable lithium battery includes a positive electrode, a negative electrode, a separator, and an electrolyte solution, wherein the positive electrode includes a positive electrode active material including a layered lithium nickel-manganese-based composite oxide, the electrolyte solution includes a non-aqueous organic solvent, a lithium salt, and an additive, and the additive includes a compound represented by Chemical Formula 1.

The electrolyte solution according to some example embodiments may improve the overall performance of the battery by forming a stable film at the interface between the electrode and the electrolyte solution during battery operation, may improve the safety and lifecycle characteristics of batteries with high-capacity, high-voltage design, and may be effective in improving low-temperature lifecycle characteristics. The electrolyte solution includes the compound represented by Chemical Formula 1 as an additive, so that compared to the case where the electrolyte solution does not include the compound represented by Chemical Formula 1, the electrolyte solution including the compound represented by Chemical Formula 1 is more effective in improving the lifecycle characteristics of rechargeable lithium batteries and improving safety by controlling an amount of gas generated in the battery during charging and discharging. In particular, the positive electrode active material including the layered lithium nickel-manganese-based composite oxide described below has an advantage of realizing high capacity and high energy density while being low-cost, but under high-voltage or high-temperature operating conditions, side reactions between the positive electrode active material including the layered lithium nickel-manganese-based composite oxide and the electrolyte solution are accelerated, leading to increased resistance and decreased lifecycle characteristics. However, when applying the electrolyte solution according to some example embodiments, the increase in resistance is effectively reduced or suppressed under high-voltage and high-temperature operating conditions, problems of deterioration of the positive electrode active material and depletion of the electrolyte solution due to repeated charging and discharging are effectively reduced or suppressed, and lifecycle characteristics can be improved at both high temperature and room temperature.

### Additive

The additive according to some example embodiments includes a compound represented by Chemical Formula 1.

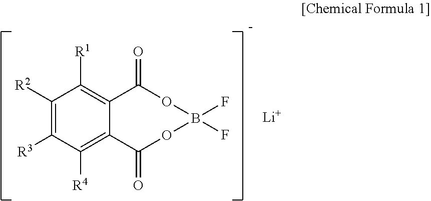

In Chemical Formula 1, R¹ to R⁴ each independently include hydrogen, a substituted or unsubstituted C1 to C20 alkyl group, a substituted or unsubstituted C2 to C20 alkenyl group, a substituted or unsubstituted C2 to C20 alkynyl group, a substituted or unsubstituted C6 to C20 aryl group, a substituted or unsubstituted C3 to C20 cycloalkyl group, a substituted or unsubstituted C3 to C20 cycloalkenyl group, a substituted or unsubstituted C3 to C20 cycloalkynyl group, a substituted or unsubstituted C2 to C20 heterocycloalkyl group, a substituted or unsubstituted C2 to C20 heterocycloalkenyl group, a substituted or unsubstituted C2 to C20 heterocycloalkynyl group, a substituted or unsubstituted C3 to C20 heteroaryl group, a substituted or unsubstituted C1 to C20 alkoxy group, an ester group, an ether group, a carboxyl group or a salt thereof, a cyano group, a carbonyl group, an imino group, or a halogen group.

For example, in Chemical Formula 1, R¹ to R⁴ may each independently be hydrogen, a substituted or unsubstituted C1 to C6 alkyl group, a substituted or unsubstituted C2 to C6 alkenyl group, a substituted or unsubstituted C2 to C6 alkynyl group, a substituted or unsubstituted C6 aryl group, a substituted or unsubstituted C3 to C6 cycloalkyl group, a substituted or unsubstituted C3 to C6 cycloalkenyl group, a substituted or unsubstituted C3 to C6 cycloalkynyl group, a substituted or unsubstituted C2 to C6 heterocycloalkyl group, a substituted or unsubstituted C2 to C6 heterocycloalkenyl group, a substituted or unsubstituted C2 to C6 heterocycloalkynyl group, a substituted or unsubstituted C3 to C6 heteroaryl group, a substituted or unsubstituted C1 to C6 alkoxy group, an ester group, an ether group, a carboxyl group or a salt thereof, a cyano group, a carbonyl group, an imino group, or a halogen group.

As an example, the compound represented by Chemical Formula 1 may be represented by Chemical Formula 1-1.

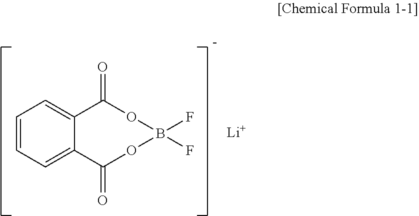

The compound represented by Chemical Formula 1 may be decomposed in the electrolyte solution even under high voltage conditions to form a stable film on the surface of the electrode, and may effectively control the elution of lithium ions from the electrode to reduce or prevent electrode decomposition. For example, the compound represented by Chemical Formula 1 is reduced and decomposed by non-aqueous organic solvents such as carbonate-based solvents to form a SEI (solid-electrolyte-interface) film at the interface between the negative electrode and the electrolyte solution, thereby reducing or preventing decomposition of the electrolyte solution and electrode, and reducing or suppressing an increase in battery internal resistance due to gas generation. It is understood that the SEI film is partially decomposed through a reduction reaction during charging and discharging and moves to the surface of the positive electrode to form a film at the interface between the positive electrode and the electrolyte solution through an oxidation reaction, thereby reducing or preventing the decomposition of the positive electrode surface and the oxidation reaction of the electrolyte solution.

The compound represented by Chemical Formula 1 may be included in an amount of about 0.1 wt % to about 3.0 wt %, for example about 0.3 wt % to about 1.5 wt %, about 0.5 wt % to about 1.3 wt %, or about 0.8 wt % to about 1.2 wt % based on a total weight of the electrolyte solution. When the compound represented by Chemical Formula 1 is included in any of the above ranges, the room temperature and high temperature lifecycle characteristics and safety of the battery can be improved without adversely affecting the overall performance of the battery, and by effectively reducing or suppressing side reactions between positive electrode active material including the layered lithium nickel-manganese-based composite oxide and the electrolyte solution under high-voltage or high-temperature conditions, resistance can be lowered and lifecycle characteristics can be improved.

The electrolyte solution may further include other additives in addition to the aforementioned additives, and the other additives may include one of vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), 2-fluoro biphenyl (2-FBP), and a combination thereof. When the electrolyte solution further includes the other additives described above, high and low temperature storage characteristics can be improved, such as effectively controlling gases generated from the positive electrode and the negative electrode.

The other additives may be included in an amount of about 0.1 wt % to about 20 wt %, for example about 0.2 wt % to about 15 wt %, or about 0.5 wt % to about 10 wt %, based on a total weight of the electrolyte solution. When the other additives are included within the above ranges, a rechargeable lithium battery having improved safety and lifecycle characteristics such as, e.g., effectively controlling gas generated from an electrode without adversely affecting the overall performance of the battery, may be implemented.

### Non-Aqueous Organic Solvent

The non-aqueous organic solvent constitutes a medium through which ions involved in the electrochemical reaction of the battery may be transferred. As the non-aqueous organic solvent, a carbonate-based solvent, an ester-based solvent, an ether-based solvent, a ketone-based solvent, an alcohol-based solvent, an aprotic solvent, or a combination thereof may be used.

In some example embodiments, the non-aqueous organic solvent may include a carbonate-based solvent and an ester-based solvent. For example, the non-aqueous organic solvent may include a carbonate-based solvent and a C1 to C8 alkyl propionate. In this case, the electrolyte solution may realize a desired or improved voltage resistance, and oxidation resistance stability, and is suitable for application to the aforementioned high-capacity, high-voltage electrode design.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), or a combination thereof.

The ester-based solvent may include, for example, methyl acetate, ethyl acetate, n-propyl acetate, dimethyl acetate, methyl propionate, ethyl propionate, propyl propionate, butyl propionate, γ-butyrolactone, decanolide, valerolactone, mevalonolactone, caprolactone, or a combination thereof.

The ether-based solvent may include, for example, dibutyl ether, tetraglyme, diglyme, dimethoxyethane, 2-methyltetrahydrofuran, tetrahydrofuran, or a combination thereof.

The ketone-based solvent may be or include, for example, cyclohexanone, and the alcohol-based solvent may include, for example, ethyl alcohol, isopropyl alcohol, or a combination thereof. The aprotic solvent may include, for example nitriles such as at least one of R—CN (wherein, R is a C2 to C20 linear, branched, or cyclic hydrocarbon group and may include a double bond, an aromatic ring, or an ether bond), and the like, amides such as dimethyl formamide, and the like, dioxolanes such as 1,3-dioxolane, and the like, or a combination thereof.

The non-aqueous organic solvent may be used alone or in a mixture. When the non-aqueous organic solvent is used in a mixture, the mixture ratio may be controlled in accordance with a desirable battery performance.

According to an example embodiment, when the non-aqueous organic solvent includes the carbonate-based solvent and the ester-based solvent, about 10 wt % to about 60 wt % of the carbonate-based solvent and about 40 wt % to about 90 wt % of the ester-based solvent based on 100 wt % of the carbonate-based solvent and the ester-based solvent may be included. In this case, it is possible to improve the voltage resistance and oxidation resistance stability of the electrolyte solution in a high-capacity and high-voltage battery system.

In addition, the carbonate-based solvent may include a cyclic carbonate and a chain carbonate. When the cyclic carbonate and the chain carbonate are mixed in a volume ratio of about 1:1 to about 1:9, the overall performance of the electrolyte solution may be improved.

The non-aqueous organic solvent may further include an aromatic hydrocarbon-based organic solvent in addition to the carbonate-based solvent. In this case, the carbonate-based solvent and the aromatic hydrocarbon-based organic solvent may be mixed in a volume ratio of about 1:1 to about 30:1.

The aromatic hydrocarbon-based organic solvent may be or include, for example, a compound represented by Chemical Formula I.

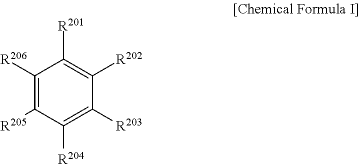

In Chemical Formula I, R²⁰¹ to R²⁰⁶ are the same or different and are at least one of hydrogen, a halogen group, a C1 to C10 alkyl group, and a C1 to C10 haloalkyl group.

The aromatic hydrocarbon-based organic solvent may include, for example, benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, or a combination thereof.

The electrolyte solution may further include vinylene carbonate or an ethylene carbonate-based compound represented by Chemical Formula II as a lifecycle improving additive.

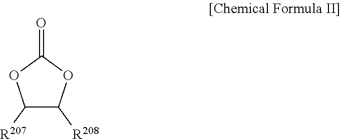

In Chemical Formula II, R²⁰⁷ and R²⁰⁸ are the same or different, and are or include at least one of hydrogen, a halogen group, a cyano group, a nitro group, and fluorinated C1 to C5 alkyl group, provided that at least one of R²⁰⁷ and R²⁰⁸ is or includes at least one of a halogen group, a cyano group, a nitro group, and a fluorinated C1 to C5 alkyl group, but both of R²⁰⁷ and R²⁰⁸ are not simultaneously or contemporaneously hydrogen.

Examples of the ethylene carbonate-based compound may be or include at least one of difluoro ethylenecarbonate, chloroethylene carbonate, dichloroethylene carbonate, bromoethylene carbonate, dibromoethylene carbonate, nitroethylene carbonate, cyanoethylene carbonate, and fluoroethylene carbonate. The amount of the additive for improving lifecycle may be used within an appropriate range.

### Lithium Salt

The lithium salt dissolved in the non-organic solvent supplies lithium ions in a battery, enables a basic operation of a rechargeable lithium battery, and improves transportation of the lithium ions between positive and negative electrodes.

Examples of the lithium salt include at least one of LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N (lithium bis(fluorosulfonyl)imide, LiFSI), LiC₄F₉SO₃, LiClO₄, LiAlO₂, LiAlCl₄, LiPO₂F₂, LiN(CₓF₂ₓ₊₁SO₂)(C_{y}F_{2y+1}SO₂), wherein x and y are natural numbers, for example, an integer ranging from 1 to 20, lithium difluoro(bisoxalato) phosphate, LiCl, LiI, LiB(C₂O₄)₂ (lithium bis(oxalato) borate, LiBOB), and lithium difluoro(oxalato)borate (LiDFOB).

The lithium salt may be in a concentration ranging from about 0.1 M to about 2.0 M. When the lithium salt is included at the above concentration range, an electrolyte solution may have desired or improved performance and lithium ion mobility due to optimal conductivity and viscosity of the electrolyte solution.

### Rechargeable Lithium Battery

Some example embodiments include a rechargeable lithium battery including a positive electrode, a negative electrode, a separator between the positive electrode and the negative electrode, and the aforementioned electrolyte solution.

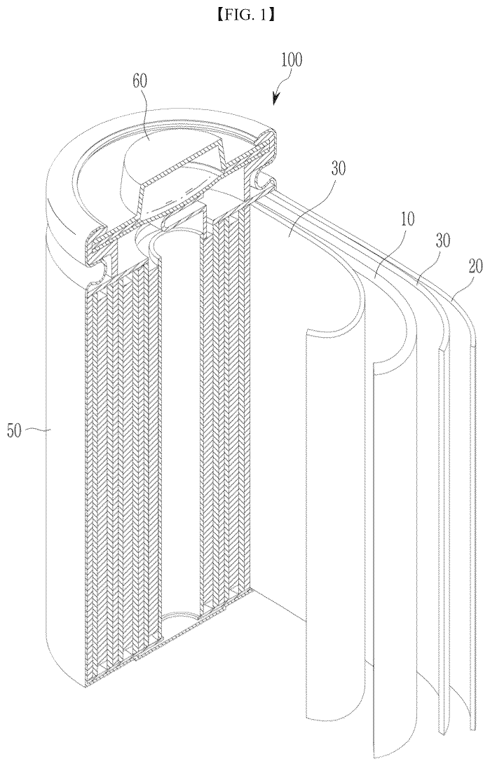

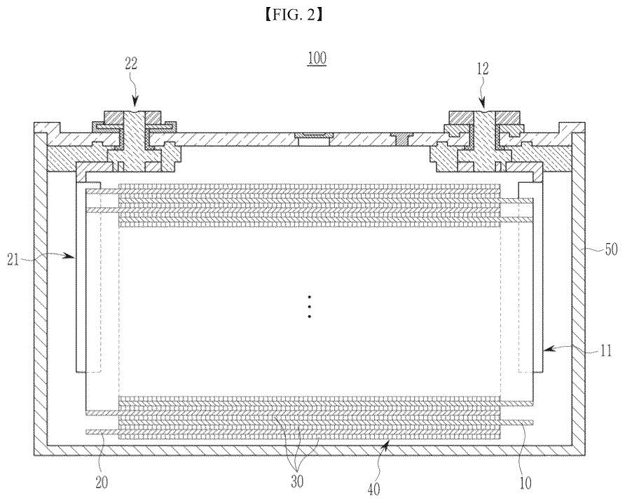

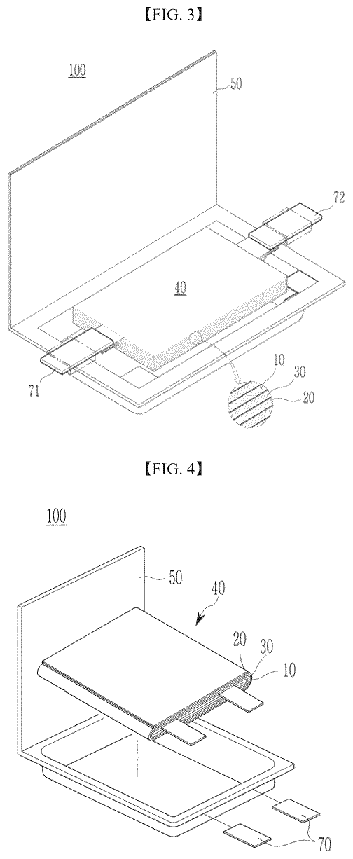

The rechargeable lithium battery may be classified into cylindrical, prismatic, pouch, coin, and the like, depending on the shape. FIGS. 1 to 4 are schematic diagrams showing the rechargeable lithium battery according to some example embodiments, where FIG. 1 illustrates a cylindrical battery, FIG. 2 illustrates a prismatic battery, and FIGS. 3 and 4 illustrate a pouch-shaped battery. Referring to FIGS. 1 to 4, the rechargeable lithium battery 100 includes an electrode assembly 40 with a separator 30 interposed between the positive electrode 10 and the negative electrode 20, and a case 50 in which the electrode assembly 40 is housed. The positive electrode 10, the negative electrode 20, and the separator 30 may be impregnated with an electrolyte solution (not shown). The rechargeable lithium battery 100 may include a sealing member 60 that seals the case 50, as shown in FIG. 1. Additionally, in FIG. 2, the rechargeable lithium battery 100 may include a positive electrode lead tab 11, a positive electrode terminal 12, a negative lead tab 21, and a negative electrode terminal 22. As shown in FIGS. 3 and 4, the rechargeable lithium battery 100 includes an electrode tab 70 illustrated in FIG. 4, that is, a positive electrode tab 71 and a negative electrode tab 72 illustrated in FIG. 3 and forming an electrical path for inducing the current formed in the electrode assembly 40 to the outside of the battery 100.

The rechargeable lithium battery according to some example embodiments may be rechargeable at a high voltage, or may be suitable for being driven at a high voltage. For example, the charging upper limit voltage of a rechargeable lithium battery may be greater than or equal to about 4.45 V, about 4.45 V to about 4.7 V, about 4.45 V to about 4.6 V, or about 4.45 V to about 4.55 V.

### Positive Electrode

The positive electrode may include a positive electrode current collector and a positive electrode active material layer on the positive electrode current collector. The positive electrode active material layer includes a positive electrode active material, and may optionally further include a binder, a conductive material, or a combination thereof.

### Positive Electrode Active Material

The positive electrode active material according to some example embodiments includes a layered lithium nickel-manganese-based composite oxide. The positive electrode active material including a layered lithium nickel-manganese-based composite oxide excludes cobalt or reduces a cobalt content, a rare metal, but has high lithium availability in the structure, resulting in desired or improved capacity and efficiency characteristics, making the positive electrode active material suitable as a material for high-capacity batteries.

A nickel content may be greater than or equal to about 60 mol %, for example about 60 mol % to about 80 mol %, about 65 mol % to about 80 mol %, about 70 mol % to about 80 mol %, about 60 mol % to about 79 mol %, about 60 mol % to about 78 mol %, or about 60 mol % to about 75 mol % based on 100 mol % of a total metal excluding lithium in the positive electrode active material. When the nickel content satisfies the above range, high capacity may be achieved and structural stability may be increased even when the cobalt content is reduced.

A manganese content may be, for example, greater than or equal to about 10 mol %, for example about 10 mol % to about 40 mol %, about 15 mol % to about 35 mol %, about 15 mol % to about 30 mol %, or about 20 mol % to about 30% based on 100 mol % of a total metal excluding lithium in the positive electrode active material. When the manganese content satisfies the above range, the positive electrode active material may improve structural stability while realizing high capacity.

For example, the layered lithium nickel-manganese-based composite oxide may be or include a lithium nickel-manganese-aluminum-based composite oxide that further contains aluminum in addition to nickel and manganese. When the layered lithium nickel-manganese-based composite oxide includes aluminum, it is advantageous to maintain a stable layered structure even when the cobalt element is excluded from the structure. An aluminum content may be greater than or equal to about 0.1 mol %, greater than or equal to about 0.5 mol %, or greater than or equal to about 1 mol %, for example greater than 0 mol % and less than or equal to 3 mol %, about 1 mol % to about 3 mol %, about 1 mol % to about 2.5 mol %, about 1 mol % to about 2 mol %, or about 1 mol % to about 1.9 mol % based on 100 mol % of a total metal excluding lithium in the positive electrode active material. When the aluminum content satisfies any of the above ranges, a stable layered structure may be maintained even when cobalt is excluded from the core particles, the problem of structure collapse due to charging and discharging may be reduced or suppressed, and long lifecycle characteristics of the positive electrode active material may be realized.

According to some example embodiments, a concentration of aluminum within the core particle may be substantially uniform. In other words, there may be no substantial concentration gradient of aluminum from the center to the surface within the core particle, or an aluminum concentration on the outside of the core particle is neither substantially higher nor substantially lower than on the inside, and that the aluminum within the core particle is substantially evenly distributed. This may be a structure obtained by synthesizing a composite oxide using nickel-manganese-aluminum-based hydroxide as a precursor by using aluminum raw materials during precursor production without additional doping of aluminum during the synthesis of the core particle. The core particle is a secondary particle in which a plurality of primary particles are agglomerated, and the aluminum content inside the primary particle may be the same or similar regardless of the location of the primary particle. That is, when a primary particle is selected at a random position in the cross-section of a secondary particle, and the aluminum content is measured inside the primary particle rather than at an interface of the primary particle, regardless of the location of the primary particle, that is, whether the primary particle is close to the center of the secondary particle or close to the surface, the aluminum content may be the same/similar/uniform. In this structure, a stable layered structure can be maintained even when cobalt is absent, or when cobalt is present in a very small amount, and aluminum by-products or aluminum aggregates are not generated, so that the capacity, efficiency, and lifecycle characteristics of the positive electrode active material can also be concurrently improved.

For example, the layered lithium nickel-manganese-based composite oxide may be or include a cobalt-free compound that does not include cobalt, or that includes a very small amount of cobalt, and a cobalt content may be less than or equal to about 0.01 mol %, less than or equal to about 0.005 mol %, or less than or equal to about 0.001 mol %, for example about 0 mol % to about 0.01 mol %, about 0 mol % to about 0.005 mol %, or about 0 mol % to about 0.001 mol % based on 100 mol % of a total metal excluding lithium in the positive electrode active material.

The layered lithium nickel-manganese-based composite oxide may be represented by Chemical Formula 2.

Liₐ₁Niₓ₁Mn_{y1}Al_{z1}M¹_{w1}O_{2-b1}X_{b1} [Chemical Formula 2]

In Chemical Formula 2, 0.9≤a1≤1.8, 0.6≤x1≤0.8, 0.1≤y1≤0.4, 0≤z1≤0.03, 0≤w1≤0.3, 0.9≤x1+y1+z1+v1+w1≤1.1, and 0≤b1≤0.1, M¹ is or includes one or more element such as B, Ba, Ca, Ce, Cr, Fe, Mg, Mo, Nb, Si, Sn, Sr, Ti, V, W, Y and Zr, and X is or includes one or more elements such as F, P, and S.

In Chemical Formula 2, 0.95a1≤1.5, or 0.95a1≤1.2. Additionally, Chemical Formula 2 may include aluminum, and in this case, 0.6≤x1≤0.8, 0.1≤y1≤0.39, 0.01≤z1≤0.03, and 0≤w1≤0.29, for example 0.6≤x1≤0.8, 0.1≤y1≤0.39, 0.01<z1≤0.03, and 0≤w1≤0.29.

In Chemical Formula 2, for example 0.6≤x1≤0.79, 0.6≤x1≤0.78, 0.6≤x1≤0.75, 0.65≤x1≤0.8, or 0.7≤x1≤0.79, 0.1≤y1≤0.35, 0.1≤y1≤0.30, 0.1≤y1≤0.29, 0.15≤y1≤0.39, or 0.2≤y1≤0.3, 0.01≤z1≤0.025, 0.01<z1≤0.02, or 0.01<z1≤0.019, 0≤w1≤0.28, 0≤w1≤0.27, 0≤w1≤0.26, 0≤w1≤0.25, 0≤w1≤0.24, 0≤w1≤0.23, 0≤w1≤0.22, 0≤w1≤0.21, 0≤w1≤0.2, 0≤w1≤0.15, 0≤w1≤0.1, or 0≤w1≤0.09.

The positive electrode active material may be in the form of particles, and the average particle diameter (D₅₀) of the particles may be, for example, about 1 μm to about 30 μm. As an example, the positive electrode active material may be or include large particles with an average particle diameter (D₅₀) of about 9 μm to about 25 μm, or may be or include small particles with an average particle diameter (D₅₀) of about 0.5 μm to about 8 μm, and the large particles and small particles are appropriately mixed. The average particle diameter (D₅₀) of large particles may be, for example, about 10 μm to about 20 μm, or about 12 μm to about 18 μm, and the average particle diameter (D₅₀) of small particles may be, for example, about 1 μm to about 6 μm, or about 2 μm to about 5 μm. The large particles may be in the form of secondary particles formed by agglomerating a plurality of primary particles, and small particles may be in the form of secondary particles, single particles, or a combination thereof.

When the positive electrode active material includes a mixture of large and small particles, the large particles may be included in an amount of about 60 wt % to about 95 wt %, or about 70 wt % to about 90 wt % and the small particles may be included in an amount of about 5 wt % to about 40 wt %, or about 10 wt % to about 30 wt % based on 100 wt % of a mixture of the large particles and small particles. When large and small grains are mixed in any of the above amount ranges, lifecycle characteristics can be improved while maximizing capacity and energy density.

The average particle diameter (D₅₀) means a diameter of particles having a cumulative volume of 50 volume % in the particle size distribution that is obtained by measuring the size (diameter or major axis length) of about 20 particles at random in a scanning electron microscope image for positive electrode active materials.

### Binder

The binder improves the binding properties of positive electrode active material particles with one another and with a current collector. Examples of the binder may include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but are not limited thereto.

### Conductive Material

The conductive material is included to provide electrode conductivity, and any electrically conductive material may be a conductive material unless the electrically conductive material causes a chemical change in the battery. Examples of the conductive material may include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including at least one of copper, nickel, aluminum, silver, and the like; a conductive polymer such as a polyphenylene derivative; or a mixture thereof.

Each, or at least one, content of the binder and the conductive material may be about 0.5 wt % to about 5 wt % based on 100 wt % of the positive electrode active material layer.

The positive electrode current collector may include Al foil, but is not limited thereto.

### Negative Electrode

The negative electrode may include a current collector and a negative electrode active material layer on the current collector, and the negative electrode active material layer may further include a negative electrode active material, a binder, a conductive material, or a combination thereof.

### Negative Electrode Active Material

The negative electrode active material may include at least one of a material that reversibly intercalates/deintercalates lithium ions, a lithium metal, a lithium metal alloy, a material capable of doping/dedoping lithium, and transition metal oxide.

The material that reversibly intercalates/deintercalates lithium ions may include, for example crystalline carbon, amorphous carbon, or a combination thereof as a carbon-based negative electrode active material. The crystalline carbon may be irregular, or sheet, flake, spherical, or fiber shaped natural graphite or artificial graphite. The amorphous carbon may be or include a soft carbon, a hard carbon, a mesophase pitch carbonization product, calcined coke, and the like.

The lithium metal alloy includes an alloy of lithium and a metal including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include silicon, a silicon-carbon composite, SiOₓ (0<x≤2), a Si-Q alloy (wherein Q is an element including at least one of an alkali metal, an alkaline-earth metal, a Group 13 element, a Group 14 element (excluding Si), a Group 15 element, a Group 16 element, a transition metal, a rare earth element, or a combination thereof, for example Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or a combination thereof), or a combination thereof. The Sn-based negative electrode active material may be or include Sn, SnO₂, a Sn alloy, or a combination thereof.

The silicon-carbon composite may be or include a composite of silicon and amorphous carbon. An average particle diameter (D₅₀) of the silicon-carbon composite particles may be, for example, about 0.5 μm to about 20 μm. According to some example embodiments, the silicon-carbon composite may be in the form of silicon particles and amorphous carbon coated on the surface of the silicon particles. For example, the silicon-carbon composite may include a secondary particle (core) in which silicon primary particles are assembled and an amorphous carbon coating layer (shell) on the surface of the secondary particle. The amorphous carbon may also be between the silicon primary particles, for example, the silicon primary particles may be coated with amorphous carbon. The secondary particles may be dispersed in an amorphous carbon matrix.

The silicon-carbon composite may further include crystalline carbon. For example, the silicon-carbon composite may include a core including crystalline carbon and silicon particles, and an amorphous carbon coating layer on the surface of the core. The crystalline carbon may be or include artificial graphite, natural graphite, or a combination thereof. The amorphous carbon may include soft carbon, hard carbon, a mesophase pitch carbonized product, calcined coke, and the like.

When the silicon-carbon composite includes silicon and amorphous carbon, a content of silicon may be about 10 wt % to about 50 wt % and a content of amorphous carbon may be about 50 wt % to about 90 wt % based on 100 wt % of the silicon-carbon composite. In addition, when the composite includes silicon, amorphous carbon, and crystalline carbon, a content of silicon may be about 10 wt % to about 50 wt %, a content of crystalline carbon may be about 10 wt % to about 70 wt %, and a content of amorphous carbon may be about 20 wt % to about 40 wt % based on 100 wt % of the silicon-carbon composite.

Additionally, a thickness of the amorphous carbon coating layer may be about 5 nm to about 100 nm. An average particle diameter (D₅₀) of the silicon particles (primary particles) may be about 10 nm to about 1 μm, or about 10 nm to about 200 nm. The silicon particles may be present as silicon alone, in the form of a silicon alloy, or in an oxidized form. The oxidized form of silicon may be represented by SiOₓ (0<x≤2). At this time, the atomic content ratio of Si:O, which indicates a degree of oxidation, may be about 99:1 to about 33:67. As used herein, when a definition is not otherwise provided, an average particle diameter (D₅₀) indicates a diameter of a particle where a cumulative volume is about 50 volume % in a particle size distribution.

The Si-based negative electrode active material, or the Sn-based negative electrode active material, may be mixed with the carbon-based negative electrode active material. When the Si-based negative electrode active material or Sn-based negative electrode active material and the carbon-based negative electrode active material are mixed, the mixing ratio of the Si-based negative electrode active material or Sn-based negative electrode active to carbon-based negative electrode active material may be a weight ratio about 1:99 to about 90:10.

### Binder

The binder is configured to adhere the negative electrode active material particles to each other, and to adhere the negative electrode active material to the current collector. The binder may be or include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamideimide, polyimide, or a combination thereof.

The aqueous binder may include a styrene-butadiene rubber, a (meth)acrylated styrene-butadiene rubber, a (meth)acrylonitrile-butadiene rubber, a (meth)acrylic rubber, a butyl rubber, a fluorine rubber, polyethylene oxide, polyvinylpyrrolidone, polyepichlorohydrin, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, or a combination thereof.

When an aqueous binder is the binder in the negative electrode active material layer, a cellulose-based compound configured to impart viscosity may be further included. As the cellulose-based compound, one or more of carboxymethyl cellulose, hydroxypropylmethyl cellulose, methyl cellulose, and alkali metal salts thereof may be mixed and used. The alkali metal may be or include Na, K, or Li.

The dry binder may be or include a polymer material capable of becoming fiber, and may be or include, for example, polytetrafluoroethylene, polyvinylidene fluoride, a polyvinylidene fluoride-hexafluoropropylene copolymer, polyethylene oxide, or a combination thereof.

### Conductive Material

The conductive material may be included to provide electrode conductivity, and any electrically conductive material may be a conductive material unless the electrically conductive material causes a chemical change in the battery. Examples of the conductive material include a carbon-based material such as at least one of natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum silver, and the like; a conductive polymer such as a polyphenylene derivative; or a mixture thereof.

A content of the negative electrode active material may be about 95 wt % to about 99.5 wt % based on 100 wt % of the negative electrode active material layer, and a content of the binder may be about 0.5 wt % to about 5 wt % based on 100 wt % of the negative electrode active material layer. For example, the negative electrode active material layer may include about 90 wt % to about 99 wt % of the negative electrode active material, about 0.5 wt % to about 5 wt % of the binder, and about 0.5 wt % to about 5 wt % of the conductive material.

### Current Collector

The negative electrode current collector may include, for example, indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof, and may be in the form of a foil, sheet, or foam. A thickness of the negative electrode current collector may be, for example, about 1 μm to about 20 μm, about 5 μm to about 15 μm, or about 7 μm to about 10 μm.

### Separator

Depending on the type of the rechargeable lithium battery, there may be a separator between the positive electrode and the negative electrode. The separator may include polyethylene, polypropylene, polyvinylidene fluoride, or a multilayer film of two or more layers thereof such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one or both surfaces of the porous substrate.

The porous substrate may be or include a polymer film formed of or including a polymer including at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The porous substrate may have a thickness of about 1 μm to about 40 μm, for example, about 1 μm to about 30 μm, about 1 μm to about 20 μm, about 5 μm to about 15 μm, or about 10 μm to about 15 μm.

The organic material may include a (meth)acrylic copolymer including a first structural unit derived from (meth)acrylamide, and a second structural unit including at least one of a structural unit derived from (meth)acrylic acid or (meth)acrylate, and a structural unit derived from (meth)acrylamidosulfonic acid or a salt thereof.

The inorganic material may include inorganic particles including Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto. An average particle diameter (D₅₀) of the inorganic particles may be about 1 nm to about 2000 nm, for example, about 100 nm to about 1000 nm, or about 100 nm to about 700 nm.

The organic material and the inorganic material may be mixed in one coating layer, or a coating layer including an organic material and a coating layer including an inorganic material may be stacked.

The thickness of the coating layer may be about 0.5 μm to about 20 μm, for example, about 1 μm to about 10 μm, or about 1 μm to about 5 μm.

Examples and Comparative Examples of the present disclosure are described below. However, the following examples are only examples of the present disclosure, and the present disclosure is not limited to the following examples.

### Example 1

### (1) Preparation of Electrolyte Solution

Hereinafter, “wt %” in the composition of electrolyte solution is based on the total amount of the electrolyte solution (lithium salt+non-aqueous organic solvent+additive+other additive, and the like.

A basic electrolyte solution was prepared by dissolving LiPF₆ lithium salt at a concentration of 1.15 M in a solvent mixed with ethylene carbonate, ethylmethyl carbonate, and dimethyl carbonate in a volume ratio of 2:4:4. An electrolyte solution is prepared by adding 0.5 wt % of the compound represented by Chemical Formula 1-1 as an additive to the basic electrolyte solution.

### (2) Manufacturing of Positive Electrode

A lithium nickel-manganese-based composite oxide (LiNi_{0.75}Mn_{0.25}O₂) with an average particle diameter (D₅₀) of about 14 μm was prepared as a positive electrode active material. 98.5 wt % of the prepared positive electrode active material, 1.0 wt % of a polyvinylidene fluoride binder, and 0.5 wt % of a carbon nanotube conductive material were mixed to prepare positive electrode active material layer slurry, and the positive electrode active material layer slurry was coated on an aluminum foil current collector and then, dried and compressed to manufacture a positive electrode.

### (3) Manufacturing of Negative Electrode

A negative electrode active material layer slurry was prepared by mixing 97.5 wt % of graphite negative electrode active material, 1.5 wt % of carboxymethyl cellulose, and 1 wt % of styrene-butadiene rubber in a water solvent. The negative electrode active material layer slurry was coated on a copper foil current collector, and subsequently dried and compressed to manufacture a negative electrode.

### (4) Manufacturing of Rechargeable Lithium Battery Cells

After interposing a polytetrafluoroethylene separator between the prepared positive and negative electrodes, and subsequently inserting them into a pouch cell, the electrolyte solution was injected thereinto to manufacture a 4.45 V pouch full cell.

### Example 2

An electrolyte solution and a rechargeable lithium battery cell were manufactured substantially in the same manner as in Example 1 with a difference that the content of the compound represented by Formula 1-1, which is an additive, was changed to 0.1 wt % in the preparation of the electrolyte solution.

### Example 3

An electrolyte solution and a rechargeable lithium battery cell were manufactured substantially in the same manner as in Example 1 with a difference that the content of the compound represented by Formula 1-1, which is an additive, was changed to 1.0 wt % in the preparation of the electrolyte solution.

### Comparative Example 1

An electrolyte solution and a rechargeable lithium battery cell were manufactured substantially in the same manner as in Example 1, with a difference that the additive, the compound represented by Chemical Formula 1-1 was not added in the preparation of the electrolyte solution.

### Comparative Example 2

An electrolyte solution and a rechargeable lithium battery cell were manufactured substantially in the same manner as in Example 1, with a difference that LiBOB was added as an additive instead of the compound represented by Chemical Formula 1-1.

### Comparative Example 3

An electrolyte solution and a rechargeable lithium battery cell were manufactured substantially in the same manner as in Example 2, with a difference that LiBOB was added as an additive instead of the compound represented by Chemical Formula 1-1.

### Comparative Example 4

An electrolyte solution and a rechargeable lithium battery cell were manufactured substantially in the same manner as in Example 3, with a difference that LiBOB was added as an additive instead of the compound represented by Chemical Formula 1-1.

### Comparative Example 5

An electrolyte solution and a rechargeable lithium battery cell were manufactured substantially in the same manner as in Example 1, with a difference that lithium nickel-cobalt-based composite oxide (LiNi_{0.5}Co_{0.2}Al_{0.3}O₂) was used instead of lithium nickel-manganese-based composite oxide (LiNi_{0.75}Mn_{0.25}O₂) in the manufacturing of the positive electrode.

Examples 1 to 3 and Comparative Examples 1 to 5 are summarized in Table 1.

TABLE 1

| | Positive electrode | Type of | Amount of |
|---|---|---|---|
| | material | additive | additive (wt %) |
| Example 1 | LiNi_{0.75}Mn_{0.25}O₂ | Chemical | 0.5 |
| | | Formula 1-1 | |
| Example 2 | | Chemical | 0.1 |
| | | Formula 1-1 | |
| Example 3 | | Chemical | 1.0 |
| | | Formula 1-1 | |
| Comparative | | — | — |
| Example 1 | | | |
| Comparative | | LiBOB | 0.5 |
| Example 2 | | | |
| Comparative | | LiBOB | 0.1 |
| Example 3 | | | |
| Comparative | | LiBOB | 1.0 |
| Example 4 | | | |
| Comparative | LiNi_{0.5}Co_{0.2}Al_{0.3}O₂ | Chemical | 0.5 |
| Example 5 | | Formula 1-1 | |

### Evaluation Example 1: Evaluation of Battery Cell Performance

The rechargeable lithium battery cells according to Examples 1 to 3 and Comparative Examples 1 to 5 were respectively charged to an upper limit voltage of 4.45 V under a constant current condition of 0.2 C, paused for 10 minutes, and discharged to 3.0 V under the condition of 0.2 C at 25° C. to proceed with initial charge and discharge.

Subsequently, the discharge capacity after storage at 60° C. for 7 days and the discharge capacity after storage for 21 days were measured, and the ratios of the discharge capacity after storage at 60° C. for 7 days to the initial discharge capacity and the ratios of the discharge capacity after storage at 60° C. for 21 days to the initial discharge capacity were calculated and expressed as capacity retention rates, which are shown in Table 2. In addition, the ratios of the discharge capacity at the first charge and discharge after storage at 60° C. for 7 days to the initial discharge capacity and the ratios of the discharge capacity at the first charge and discharge after storage at 60° C. for 21 days to the initial discharge 5 capacity were calculated and expressed as capacity recovery rates as shown in Table 2.

TABLE 2

| | 60° C., 7 days storage | | 60° C., 21 days storage | |
|---|---|---|---|---|
| | Capacity | Capacity | Capacity | Capacity |
| | retention | retention | retention | retention |
| | rate (%) | rate (%) | rate (%) | rate (%) |
| Example 1 | 92.3 | 97.8 | 87.2 | 97.1 |
| Example 2 | 88.6 | 96.9 | 83.5 | 96.2 |
| Example 3 | 89.3 | 97 | 84.2 | 96.3 |
| Comparative | 83.9 | 95.6 | 78.8 | 94.9 |
| Example 1 | | | | |
| Comparative | 86.9 | 96.3 | 82.1 | 93.1 |
| Example 2 | | | | |
| Comparative | 85.0 | 96.0 | 80.0 | 95.3 |
| Example 3 | | | | |
| Comparative | 86.4 | 96.2 | 81.3 | 95.5 |
| Example 4 | | | | |
| Comparative | 76.3 | 93.4 | 71.2 | 92.7 |
| Example 5 | | | | |

Referring to Table 2, in the case of Examples 1 to 3, which used a layered lithium nickel-manganese-based composite oxide as the positive electrode active material and included a compound represented by Chemical Formula 1-1 as an additive to the electrolyte solution, the capacity retention rates and capacity recovery rates have been improved compared to Comparative Examples.

### Evaluation Example 2: Room-temperature Lifecycle Characteristics

The rechargeable lithium battery cells according to Examples 1 to 3 and Comparative Examples 1 to 5 were respectively charged to an upper limit voltage of 4.45 V under a constant current condition of 0.2 C, paused for 10 minutes, and discharged to 3.0 V under the condition of 0.2 C at 25° C. to proceed with initial charge and discharge. Subsequently, the cycle of charging at 0.33 C and discharging at 1.0 C was repeated 200 times in a voltage range of 3.0 V to 4.45 V at 25° C., and the ratios of the 200th cycle discharge capacity to the initial discharge capacity were calculated and expressed as room-temperature lifecycle as shown in Table 3.

TABLE 3

| | Room-temperature lifecycle |
|---|---|
| | (%, 25° C., 200 cyc) |
| Example 1 | 92.3 |
| Example 2 | 89.2 |
| Example 3 | 91.6 |
| Comparative | 84.4 |
| Example 1 | |
| Comparative | 87.1 |
| Example 2 | |
| Comparative | 86.2 |
| Example 3 | |
| Comparative | 90.9 |
| Example 4 | |
| Comparative | 77.2 |
| Example 5 | |

Referring to Table 3, in the case of Examples 1 to 3, which used a layered lithium nickel-manganese-based composite oxide as the positive electrode active material and included a compound represented by Chemical Formula 1-1 as an additive to the electrolyte solution, the room-temperature lifecycle characteristics have been improved compared to Comparative Examples 1 to 3 and 5.

### Evaluation Example 3: Evaluation of High-Temperature Lifecycle Characteristics

The rechargeable lithium battery cells according to Examples 1 to 3 and Comparative Examples 1 to 5 were respectively charged to an upper limit voltage of 4.45 V under a constant current condition of 0.2 C, paused for 10 minutes, and discharged to 3.0 V under the condition of 0.2 C at 25° C. to proceed with initial charge and discharge. Subsequently, the cycle of charging at 0.33 C and discharging at 1.0C was repeated 200 times in a voltage range of 3.0 V to 4.45 V at 45° C., and the ratios of the 200th cycle discharge capacity to the initial discharge capacity were calculated and expressed as high-temperature lifecycle as shown in Table 4.

TABLE 4

| | High-temperature lifecycle |
|---|---|
| | (%, 45° C., 200 cyc) |
| Example 1 | 89.2 |
| Example 2 | 86.1 |
| Example 3 | 88.5 |
| Comparative | 81.3 |
| Example 1 | |
| Comparative | 84.3 |
| Example 2 | |
| Comparative | 83.1 |
| Example 3 | |
| Comparative | 87.8 |
| Example 4 | |
| Comparative | 74.1 |
| Example 5 | |

Referring to Table 4, in the case of Examples 1 to 3, which used a layered lithium nickel-manganese-based composite oxide as the positive electrode active material and included a compound represented by Chemical Formula 1-1 as an additive to the electrolyte solution, the high-temperature lifecycle characteristics have been improved compared to Comparative Examples 1 to 3 and 5.

### Evaluation Example 4: Amount of Gas Generated after Storage of 60° C.

The rechargeable lithium battery cells of Examples 1 to 3 and Comparative Examples 1 to 5 were manufactured into 4.4 V class 30 mAh cells and then, allowed to stand at 60° C. for 10 days and 30 days to measure an amount (ml) of gas generated at the 10th day and 30th day by using a refinery gas analyzer (RGA), and the results are shown in Table 5.

TABLE 5

| | Amount of gas generated | Amount of gas generated |
|---|---|---|
| | (ml, 60° C., 10^{th} day) | (ml, 60° C., 30^{th} day) |
| Example 1 | 12.3 | 32.2 |
| Example 2 | 14.1 | 39.1 |
| Example 3 | 15.5 | 41.4 |
| Comparative | 16.7 | 44.8 |
| Example 1 | | |
| Comparative | 15.9 | 43.7 |
| Example 2 | | |
| Comparative | 16.2 | 47.4 |
| Example 3 | | |
| Comparative | 19.5 | 53.2 |
| Example 4 | | |
| Comparative | 22.7 | 62.4 |
| Example 5 | | |

Referring to Table 5, in the case of Examples 1 to 3, which used a layered lithium nickel-manganese-based composite oxide as the positive electrode active material and included a compound represented by Chemical Formula 1-1 as an additive to the electrolyte solution, the amounts of gas generated have decreased compared to Comparative Examples.

While this disclosure has been described in connection with what is presently considered to be practical example embodiments, it is to be understood that the disclosure is not limited to the disclosed example embodiments. On the contrary, the disclosure is intended to cover various modifications and equivalent arrangements included within the spirit and scope of the claims.

Description of symbols

| | |
|---|---|
| 100: rechargeable lithium battery | 10: positive electrode |
| 11: positive electrode lead tab | 12: positive terminal |
| 20: negative electrode | 21: negative electrode lead tab |
| 22: negative terminal | 30: separator |
| 40: electrode assembly | 50: case |
| 60: sealing member | 70: electrode tab |
| 71: positive electrode tab | 72: negative electrode tab |

What is claimed is:

1. A rechargeable lithium battery comprising a positive electrode, a negative electrode, a separator, and an electrolyte solution, wherein:
the positive electrode includes a positive electrode active material including a layered lithium nickel-manganese-based composite oxide,
the electrolyte solution includes a non-aqueous organic solvent, a lithium salt, and an additive, and
the additive includes a compound represented by Chemical Formula 1: 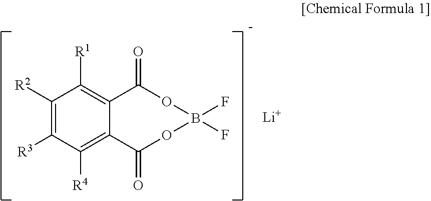
wherein, in Chemical Formula 1,
R¹ to R⁴ each independently comprise hydrogen, a substituted or unsubstituted C1 to C20 alkyl group, a substituted or unsubstituted C2 to C20 alkenyl group, a substituted or unsubstituted C2 to C20 alkynyl group, a substituted or unsubstituted C6 to C20 aryl group, a substituted or unsubstituted C3 to C20 cycloalkyl group, a substituted or unsubstituted C3 to C20 cycloalkenyl group, a substituted or unsubstituted C3 to C20 cycloalkynyl group, a substituted or unsubstituted C2 to C20 heterocycloalkyl group, a substituted or unsubstituted C2 to C20 heterocycloalkenyl group, a substituted or unsubstituted C2 to C20 heterocycloalkynyl group, a substituted or unsubstituted C3 to C20 heteroaryl group, a substituted or unsubstituted C1 to C20 alkoxy group, an ester group, an ether group, a carboxyl group or a salt thereof, a cyano group, a carbonyl group, an imino group, or a halogen group.

2. The rechargeable lithium battery as claimed in claim 1, wherein in Chemical Formula 1, R¹ to R⁴ each independently comprise hydrogen, a substituted or unsubstituted C1 to C6 alkyl group, a substituted or unsubstituted C2 to C6 alkenyl group, a substituted or unsubstituted C2 to C6 alkynyl group, a substituted or unsubstituted C6 aryl group, a substituted or unsubstituted C3 to C6 cycloalkyl group, a substituted or unsubstituted C3 to C6 cycloalkenyl group, a substituted or unsubstituted C3 to C6 cycloalkynyl group, a substituted or unsubstituted C2 to C6 heterocycloalkyl group, a substituted or unsubstituted C2 to C6 heterocycloalkenyl group, a substituted or unsubstituted C2 to C6 heterocycloalkynyl group, a substituted or unsubstituted C3 to C6 heteroaryl group, a substituted or unsubstituted C1 to C6 alkoxy group, an ester group, an ether group, a carboxyl group or a salt thereof, a cyano group, a carbonyl group, an imino group, or a halogen group.

3. The rechargeable lithium battery as claimed in claim 1, wherein the compound represented by Chemical Formula 1 is represented by Chemical Formula 1-1:

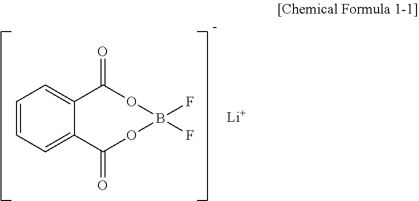

4. The rechargeable lithium battery as claimed in claim 1, wherein the compound represented by Chemical Formula 1 is included in an amount of about 0.1 wt % to about 3.0 wt % based on a total weight of the electrolyte solution.

5. The rechargeable lithium battery as claimed in claim 1, wherein the compound represented by Chemical Formula 1 is included in an amount of about 0.8 wt % to about 1.2 wt % based on a total weight of the electrolyte solution.

6. The rechargeable lithium battery as claimed in claim 1, wherein the electrolyte solution comprises other additives including at least one of vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

7. The rechargeable lithium battery as claimed in claim 1, wherein a nickel content is about 60 mol % to about 80 mol % and a manganese content is greater than or equal to about 10 mol % based on 100 mol % of a total metal excluding lithium in the positive electrode active material.

8. The rechargeable lithium battery as claimed in claim 1, wherein:
the layered lithium nickel-manganese-based composite oxide further comprises aluminum, and
an aluminum content is about 1 mol % to about 3 mol % based on 100 mol % of a total metal excluding lithium in the positive electrode active material.

9. The rechargeable lithium battery as claimed in claim 1, wherein a cobalt content is about 0 mol % to about 0.01 mol % based on 100 mol % of a total metal excluding lithium in the positive electrode active material.

10. The rechargeable lithium battery as claimed in claim 1, wherein the layered lithium nickel-manganese-based composite oxide is represented by Chemical Formula 2:
Liₐ₁Niₓ₁Mn_{y1}Al_{z1}M¹_{w1}O_{2-b1}X_{b1} [Chemical Formula 2]
wherein, in Chemical Formula 2, 0.9≤a1≤1.8, 0.6≤x1≤0.8, 0.1≤y1≤0.4, 0≤z1≤0.03, 0≤w1≤0.3, 0.9≤x1+y1+z1+v1+w1≤1.1, 0≤b1≤0.1, M¹ includes one or more of B, Ba, Ca, Ce, Cr, Fe, Mg, Mo, Nb, Si, Sn, Sr, Ti, V, W, Y and Zr, and X includes one or more of F, P, and S.

11. The rechargeable lithium battery as claimed in claim 1, wherein the positive electrode active material comprises at least one of:
particles having an average particle diameter (D₅₀) of about 9 μm to about 25 μm, and
particles having an average particle diameter (D₅₀) of about 0.5 μm to about 8 μm.

12. The rechargeable lithium battery as claimed in claim 1, wherein the rechargeable lithium battery has a charging upper limit voltage equal to or more than about 4.45 V.
